(19) United States
(12) Patent Application Publication
(10) Pub. No.: US 2015/0042907 A1
(43) Pub. Date: Feb. 12, 2015

(54) TOUCH PANEL WITH AN ANTIREFLECTION LAYER

(71) Applicant: Luxtaltek Corporation, Miaoli County (TW)

(72) Inventors: Chung-Hsiang LIN, Taipei City (TW); Kan-Yuan LEE, Hsinchu City (TW)

(21) Appl. No.: 14/453,085

(22) Filed: Aug. 6, 2014

(30) Foreign Application Priority Data
Aug. 7, 2013 (TW) 102128276
Aug. 7, 2013 (TW) 102214820

(51) Int. Cl. G06F 3/041

(52) U.S. Cl. CPC G06F 3/041
USPC 349/12

(57) ABSTRACT

A touch panel includes: a transparent rigid window screen having an inner surface and an outer surface that is adapted to be touched by a user; and a touch sensor module secured to the inner surface of the transparent rigid window screen for detecting at least one touch position of the user's touch on the outer surface. The outer surface of the transparent rigid window screen is formed with an antireflection layer that includes a plurality of protruding pillars protruding outwardly from the outer surface and arranged to take a form of a quasicrystalline pattern having a plurality of pattern sections that are collectively ordered but not periodic.

### CROSS-REFERENCE TO RELATED APPLICATIONS

This application claims priority of Taiwanese Application Nos. 102128276 and 102214820, both filed on Aug. 7, 2013.

### FIELD OF THE INVENTION

This invention relates to a touch panel, more particularly to a touch panel with an antireflection layer that includes a plurality of protruding pillars arranged to take a form of a quasicrystalline pattern.

### BACKGROUND OF THE INVENTION

U.S. Patent Application Publication No. 2011/0221699 discloses a touch screen apparatus that includes a liquid crystal display (LCD) module, a touch panel laminated on the LCD module, and a conductive resin interposed between the LCD module and the touch panel for improving adhesion and noise shielding. The touch panel includes a window glass, a printing layer printed on an inner surface of the window glass, a dielectric layer, and first and second conductive layers attached to two opposite sides of the dielectric layer. The first conductive layer is attached to the printing layer through an adhesive.

U.S. Pat. No. 7,724,241B2 discloses a conventional touch panel that includes a film-like upper substrate, an upper conductive layer formed on the upper substrate, a lower substrate, a lower conductive layer formed on the lower substrate, a spacer disposed between the upper and lower conductive layers, and an antireflection layer disposed between the upper and lower substrates and including a low refraction layer and a high refraction layer laminated with the low refraction layer. The lower substrate is made from glass or acrylic resin. The upper substrate is made from a polymeric or resin material, and provides an outer main surface for pressing with a finger of a user or a pen. However, since the upper substrate is made from the polymeric material, it tends to be scratched, crack or deform after being used for a period of time. In addition, the conventional touch panel has a multilayered structure that is complicated.

### SUMMARY OF THE INVENTION

Therefore, the object of the present invention is to provide a touch panel that may overcome the aforesaid drawbacks associated with the prior art.

According to this invention, there is provided a touch panel that comprises: a transparent rigid window screen having an inner surface and an outer surface that is adapted to be touched by a user; and a touch sensor module secured to the inner surface of the transparent rigid window screen for detecting at least one touch position of the user's touch on the outer surface. The outer surface of the transparent rigid window screen is formed with an antireflection layer that includes a plurality of protruding pillars protruding outwardly from the outer surface and arranged to take a form of a quasicrystalline pattern having a plurality of pattern sections that are collectively ordered but not periodic.

### BRIEF DESCRIPTION OF THE DRAWINGS

In drawings which illustrate embodiments of the invention,

FIG. 1 is a schematic view of the first embodiment of a touch panel according to the present invention;

FIG. 2 is an enlarged view of encircled portion A in FIG. 1 to show the structure of an antireflection layer of the first embodiment;

FIG. 3 is an enlarged fragmentary perspective view of the first embodiment;

FIG. 4 is a photo image showing a pattern section of a quasicrystalline pattern of protruding pillars of the antireflection layer of the first embodiment;

FIG. 5 is a plot of a reflectance map in relation to a height of the protruding pillars and a period between every two adjacent ones of the protruding pillars in the pattern section of the first embodiment;

FIG. 6 is an enlarged fragmentary perspective view of an antireflective layer of the second embodiment of the touch panel according to the present invention;

FIG. 7 is a plot of a reflectance map in relation to a height of the protruding pillars and a period between every two adjacent ones of the protruding pillars in a pattern section of a quasicrystalline pattern of the second embodiment;

FIG. 8 is an enlarged fragmentary perspective view of an antireflection layer of the third embodiment of the touch panel; and

FIG. 9 is a plot of a reflectance map in relation to the height of the protruding pillars and a period between every two adjacent ones of the protruding pillars in a pattern section of a quasicrystalline pattern of the third embodiment.

### DETAILED DESCRIPTION OF THE EMBODIMENTS

Before the present invention is described in greater detail with reference to the embodiments, it should be noted herein that like elements are denoted by the same reference numerals throughout the disclosure.

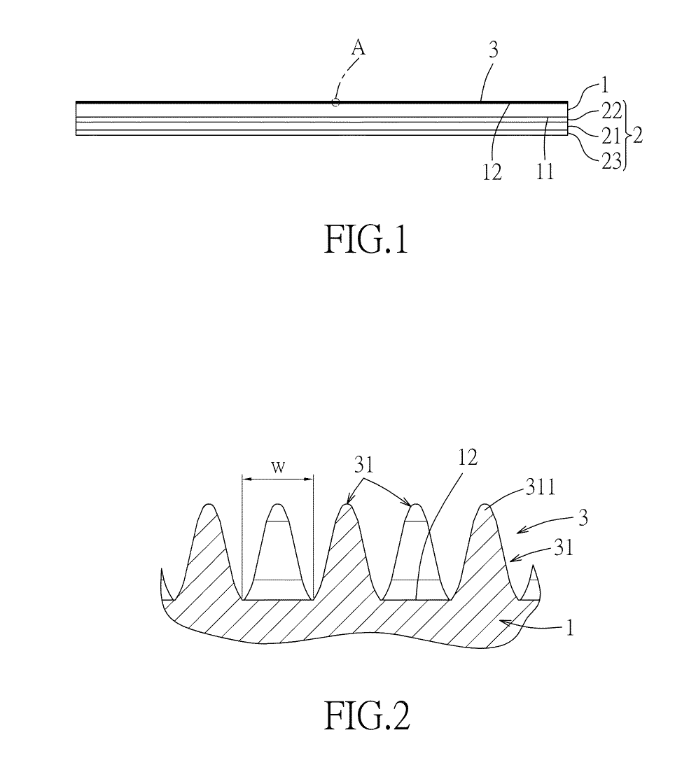

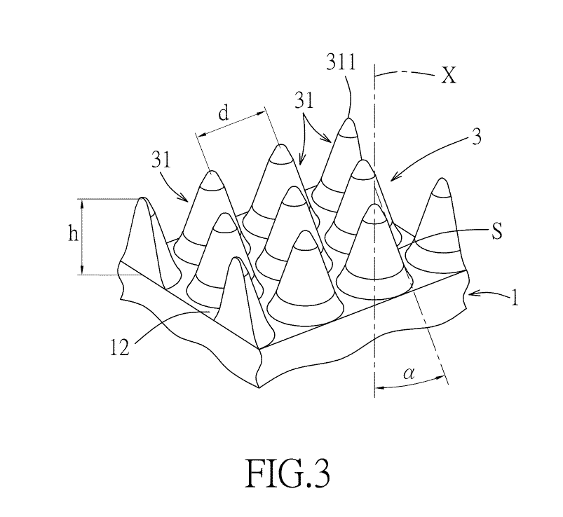

FIGS. 1 to 3 illustrate the first embodiment of a touch panel according to the present invention. The touch panel includes: a transparent rigid window screen 1 having an inner surface 11 and an outer surface 12 that is adapted to be touched by a user; and a capacitive type touch sensor module 2 secured to the inner surface 11 of the transparent rigid window screen 1 for detecting at least one touch position of the user's touch on the outer surface 12. The outer surface 12 of the transparent rigid window screen 1 is formed with an antireflection layer 3 that includes a plurality of protruding pillars 31 that protrude outwardly from the outer surface 12 and that are arranged to take a form of a quasicrystalline pattern. The quasicrystalline pattern has a plurality of pattern sections that are collectively ordered but not periodic.

The capacitive type touch sensor module 2 includes a dielectric substrate 21, a patterned first conductive layer 22 formed on one side of the dielectric substrate 21, and a patterned second conductive layer 23 formed on the other side of the dielectric substrate 21. The patterned first and second conductive layers 22, 23 cooperatively form an array of touch sensor regions (not shown) that are capable of detecting multi-touch positions of the user's touch on the outer surface 12.

Preferably, the transparent rigid window screen 1 and the protruding pillars 31 are made from the same material, and more preferably, the transparent rigid window screen 1 and the protruding pillars 31 are made from a hard material selected from the group consisting of silicon, quartz, glass, and sapphire. In this embodiment, the transparent rigid window screen 1 and the protruding pillars 31 are integrally formed by etching a silicon substrate. As such, the antireflection layer 3 thus formed has a relatively high hardness, which permits the antireflection layer 3 to be resistant to scratching, cracking and deformation.

Preferably, each of the protruding pillars 31 defines a central axis (X) perpendicular to the outer surface 12 of the transparent rigid window screen 1, and is tapered away from the outer surface 12 of the transparent rigid window screen 1 to define a slope (S) that forms an acute angle (α) with the central axis (X). The acute angle (α) is greater than 5° and less than 45°. In this embodiment, the acute angle (α) is about 22°. Each of the protruding pillars 31 is generally conical in shape, and has a rounded tip end portion 311 that is distal from the outer surface 12 of the transparent rigid window screen 1.

Preferably, each of the protruding pillars 31 has a height (h) relative to the outer surface 12 of the transparent rigid window screen 1. The height (h) is greater than 50 nm and less than 2000 nm. Each of the pattern sections of the quasicrystalline pattern has a period (d) between the central axes (X) of every two adjacent ones of the protruding pillars 31 thereof that is between 50 nm and 2000 nm. More preferably, the height (h) of each of the protruding pillars 31 is between 300 nm and 2000 nm, and the period (d) between every two adjacent ones of the protruding pillars 31 ranges between 100 nm and 1000 nm. In this embodiment, each of the protruding pillars 31 has a height (h) of 300 nm and a maximum width (w) of 250 nm, and each of the pattern sections of the quasicrystalline pattern has a period (d) of 350 nm.

Preferably, each of the pattern sections of the quasicrystalline pattern has a square-triangle arrangement system, and exhibits n-fold local symmetry, in which n is greater than or equal to 6. More preferably, n is greater than or equal to 12.

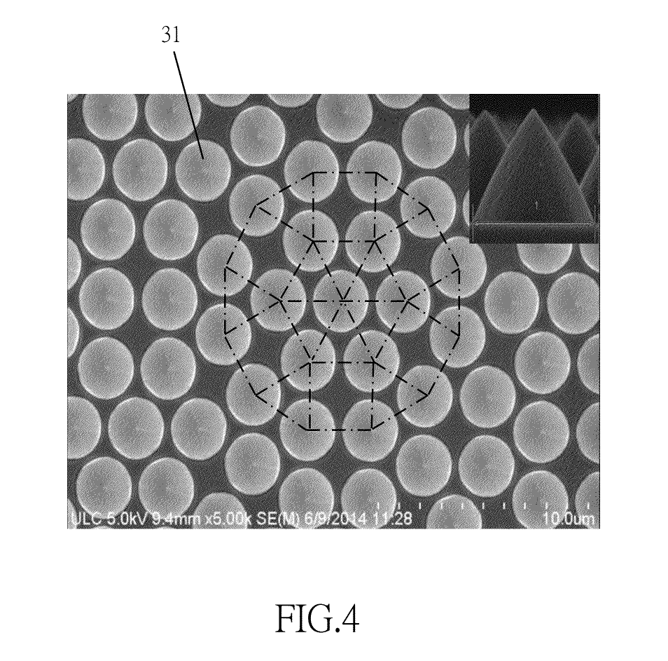

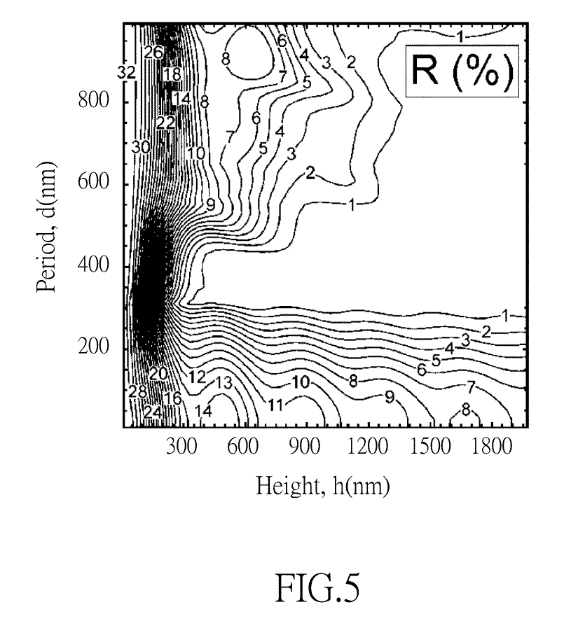

FIG. 4 is a photo image showing a pattern section of the quasicrystalline pattern of the protruding pillars 31 of the first embodiment. The dashed lines shown in FIG. 4 are drawn by connecting central points of the protruding pillars 31 in order to show one of the pattern sections of the quasicrystalline pattern of the protruding pillars 31. In this embodiment, each of the pattern sections of the quasicrystalline pattern consists of a plurality of triangles and squares, and has 12-fold local symmetry. The higher the number of the symmetry, the greater the anti-glare effect that may be achieved for the touch panel.

FIG. 5 is a plot of a reflectance map of the touch panel of the first embodiment in relation to the height (h) of the protruding pillars 31 and the period (d) between every two adjacent ones of the protruding pillars 31 in each of the pattern sections under an incident visible light (750 nm) having an incident angle of π/4. The results show that the height (h) of the protruding pillars 31 and the period (d) between every two adjacent ones of the protruding pillars 31 in each of the pattern sections have significant effect on the reflectance of the touch panel and that the first embodiment (with the acute angle (α) being about 22°) has relatively broad ranges of the height (h) and the period (d) for designing and manufacturing the protruding pillars 31 in order to achieve a low reflectance for the touch panel. As shown in FIG. 5, the reflectance of the touch panel may be less than 10% when the height (h) is within a range of about 300 nm to 2000 nm and the period (d) is within a range of about 150 to 1000 nm. It is noted that the silicon substrate (without the antireflection layer 3) has a reflectance of 35% under an incident visible light (750 nm) having an incident angle of π/4.

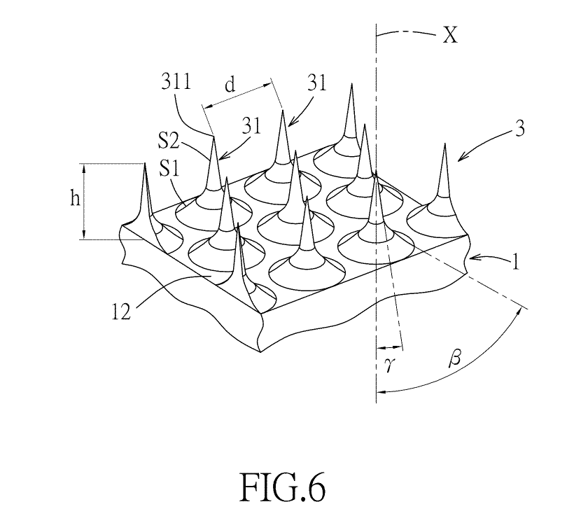

FIG. 6 illustrates the structure of an antireflection layer 3 of the second embodiment of the touch panel. The second embodiment differs from the first embodiment in that each of the protruding pillars 31 has lower and upper slopes (S1, S2). The lower slope (S1) forms a first acute angle (β) with the central axis (X). The first acute angle (β) is about 45°. The upper slope (S2) forms a second acute angle (γ) with the central axis (X). The second acute angle (γ) is about 5°. In this embodiment, each of the protruding pillars 31 has a height (h) of 400 nm and a maximum width (w) of 600 nm, and each of the pattern sections of the quasicrystalline pattern has a period (d) of 750 nm.

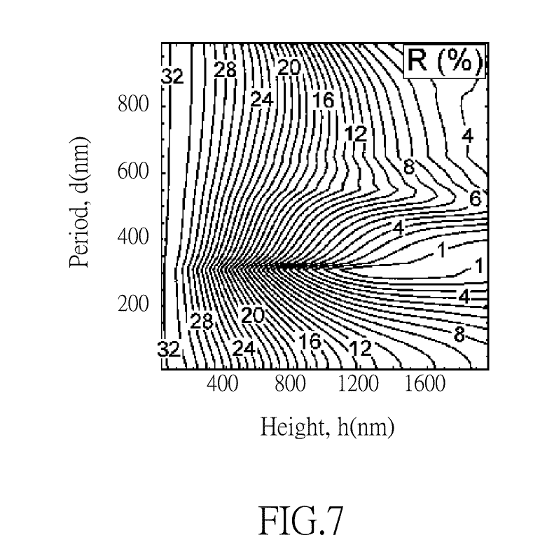

FIG. 7 is a plot of a reflectance map of the touch panel of the second embodiment in relation to the height (h) of the protruding pillars 31 and the period (d) between every two adjacent ones of the protruding pillars 31 in each of the pattern sections under an incident visible light (750 nm) having an incident angle of π/4. The results show that the second embodiment has narrower ranges of the height (h) and the period (d) as compared to those of the first embodiment for designing and manufacturing the protruding pillars 31 in order to achieve a low reflectance for the touch panel.

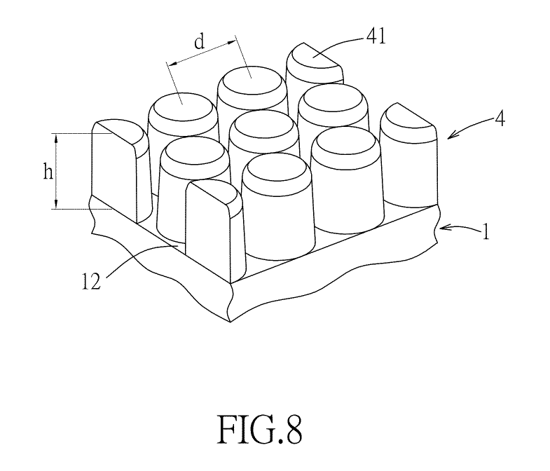

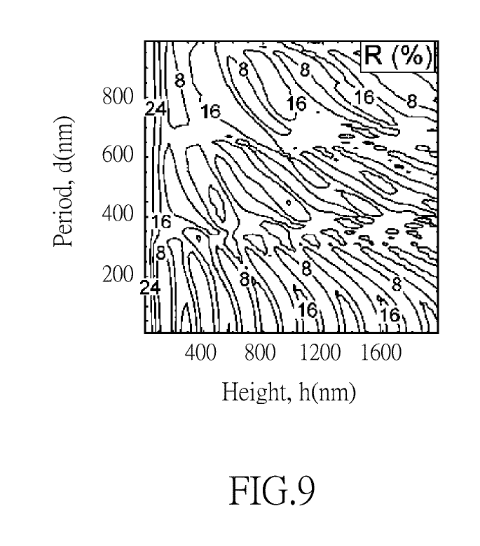

FIG. 8 illustrates the structure of an antireflection layer 4 of the third embodiment of the touch panel. The third embodiment differs from the first embodiment in that the acute angle (α) is substantially 0°, i.e., the protruding pillars 41 are non-tapered. Each of the protruding pillars 41 has a height (h) of 900 nm and a maximum width (w) of 300 nm, and each of the pattern sections of the quasicrystalline pattern has a period (d) of 450 nm.

FIG. 9 is a plot of a reflectance map of the touch panel of the third embodiment in relation to the height (h) of the protruding pillars 41 and the period (d) between every two adjacent ones of the protruding pillars 41 in each of the pattern sections under an incident visible light (750 nm) having an incident angle of π/4. The results show that the third embodiment has much narrower ranges of the height (h) and the period (d) as compared to those of the first and second embodiments for designing and manufacturing the protruding pillars 41 in order to achieve a low reflectance for the touch panel.

By forming the outer surface 12 of the transparent rigid window screen 1 of the touch panel of the present invention with the antireflection layer 3 that includes a plurality of the protruding pillars arranged to take the form of a quasicrystalline pattern, the reflection is reduced from about 35% (which is the reflectance of the silicon substrate without the antireflection layer) to less than 10% and the aforesaid drawbacks associated with the prior art may be eliminated. Moreover, by forming the protruding pillars 31 of the antireflection layer 3 to taper away from the outer surface 12 of the transparent rigid window screen 1, the reflectance of the touch panel of the present invention can be considerably reduced and the freedom of designing and manufacturing the protruding pillars 31 can be significantly broadened.

While the present invention has been described in connection with what are considered the most practical embodiments, it is understood that this invention is not limited to the disclosed embodiments but is intended to cover various arrangements included within the spirit and scope of the broadest interpretation and equivalent arrangements.

What is claimed is:

1. A touch panel comprising:
a transparent rigid window screen having an inner surface and an outer surface that is adapted to be touched by a user; and
a touch sensor module secured to said inner surface of said transparent rigid window screen for detecting at least one touch position of the user's touch on said outer surface;
wherein said outer surface of said transparent rigid window screen is formed with an antireflection layer that includes a plurality of protruding pillars protruding outwardly from said outer surface and arranged to take a form of a quasicrystalline pattern having a plurality of pattern sections that are collectively ordered but not periodic.

2. The touch panel of claim 1, wherein said protruding pillars are tapered away from said outer surface of said transparent rigid window screen.

3. The touch panel of claim 1, wherein said transparent rigid window screen and said protruding pillars are made from the same material.

4. The touch panel of claim 1, wherein said transparent rigid window screen and said protruding pillars are made from a material selected from the group consisting of silicon, quartz, glass, and sapphire.

5. The touch panel of claim 2, wherein each of said protruding pillars defines a central axis perpendicular to said outer surface of said transparent rigid window screen, and has a slope that forms an acute angle with said central axis, said acute angle being greater than 5° and less than 45°.

6. The touch panel of claim 2, wherein each of said protruding pillars is generally conical in shape, and has a rounded tip end portion distal from said outer surface of said transparent rigid window screen.

7. The touch panel of claim 1, wherein each of said protruding pillars defines a central axis perpendicular to said outer surface of said transparent rigid window screen and has a height relative to said outer surface of said transparent rigid window screen that is greater than 50 nm and less than 2000 nm, each of said pattern sections of said quasicrystalline pattern having a period between the central axes (X) of every two adjacent ones of said protruding pillars thereof that is greater than 100 nm and less than 1000 nm.

8. The touch panel of claim 1, wherein each of said pattern sections of said quasicrystalline pattern exhibits n-fold local symmetry, in which n is greater than or equal to 6.
